(19) United States
(12) Patent Application Publication
(10) Pub. No.: US 2025/0194751 A1
(43) Pub. Date: Jun. 19, 2025

(54) A METHOD OF MANUFACTURING A STIFFENER MATERIAL

(71) Applicant: Texon Management Limited, London (GB)

(72) Inventors: Paul MALLORY, Saltburn-by-the-Sea, Cleveland (GB); Brian WALSH, Saltburn-by-the-Sea, Cleveland (GB); Roksana SAMBORSKA-SKOWRON, Saltburn-by-the-Sea, Cleveland (GB)

(21) Appl. No.: 18/846,789

(22) PCT Filed: Mar. 15, 2023
(86) PCT No.: PCT/EP2023/056623

§ 371 Date: Sep. 13, 2024

(30) Foreign Application Priority Data
Mar. 15, 2022 (GB) 2203600.8

(51) Int. Cl. A43B 23/08; B30B 5/06; B32B 5/02; B32B 5/26; B32B 27/36; B32B 37/06; B32B 37/08; B32B 37/10

(52) U.S. Cl. CPC A43B 23/088; B30B 5/06; B32B 5/02; B32B 5/26; B32B 27/36; B32B 37/06; B32B 37/08; B32B 37/1027; B32B 2250/02

(57) ABSTRACT

The present invention provides a method of manufacturing a stiffener material comprising: providing an uncompressed felt layer comprising a primary fibrous material having a density of between 0.08 g/cm3 and 0.16 g/cm3; passing the felt layer through a double belt press; wherein as the felt layer is passed through the double belt press it is maintained under constant pressure whilst first being heated to within 20° C. of a melting point of the primary fibrous material and is subsequently cooled to below the glass temperature of the primary fibrous material to form a compressed material. A stiffener material manufactured according to the method of the present invention is also provided.

### FIELD OF THE INVENTION

The present invention relates to felt materials suitable for use as stiffeners in footwear and methods of producing such materials.

### BACKGROUND TO THE INVENTION

Nearly all modern footwear include stiffeners in their internal structure. Footwear stiffeners include, but not limited to, toe puffs at the front and heel counters in the heel to give and to retain the desired shape throughout the active life of the footwear.

A heel counter is typically positioned between an external material and a lining of an upper in the heel area of a shoe. The purpose of the heel counter is to strengthen a back part of the shoe, to provide a suitable shape, and to prevent the back part of the shoe from losing said shape, whilst providing some form of support to a heel area and maintaining a positive element of foot physiology for a wearer. The most commonly used manufacturing processes used to produce heel counters include filmic extrusion, impregnation, and sintering.

One material currently used to form heel counters is a polyester non-woven textile impregnated with an emulsion polymer. In particular, a polyester non-woven textile is impregnated with water-based SBR latex at the ration of approximatively 2:1 of impregnate to fibre. This material is then cured, dried in an oven, and finally coated with a hot-melt adhesive. The compatibility of a heel counter with fabric and any adhesives used during shoe manufacture can affect the resiliency, stiffness, and shape retention of the heel counter and the shoe.

SBR latex is a synthetic rubber derived from organic compounds. It is a consumable product that is not considered to be environmentally friendly. In order to improve environmental credentials and sustainability manufacturers and consumers are unhappy to use and purchase materials made from products such as SBR latex. Materials made from recycled or sustainable products are now preferred. Therefore, there is a need for an improved material for use as a stiffener that is made more sustainably. In particular, it is desirable to avoid the need for latex impregnation without any significant detriment to the material properties of the stiffener. A method of manufacturing such materials is also required.

### SUMMARY OF THE INVENTION

The present invention provides a method of manufacturing a stiffener material comprising:
providing a uncompressed felt layer comprising a primary fibrous material having a density of between 0.08 g/cm³ and 0.16 g/cm³;
passing the felt layer through a double belt press; wherein
as the felt layer is passed through the double belt press it is maintained under constant pressure whilst first being heated to within 20° C. of a melting point of the primary fibrous material and is subsequently cooled to below the glass temperature of the primary fibrous material to form a compressed material.

The method of the present invention is advantageous in that it can provide a stiffener material with material properties similar to prior art materials impregnated with latex without the requirement for such impregnation. This is achieved through use of a double belt press with integrated contact heating and contact cooling. In particular, the heating of the primary fibre to within 20° C. of the melting point of the primary fibrous material followed by cooling to below the glass temperature of the primary fibrous material whilst the felt layer is maintained under pressure in the double belt press results in a material with advantageous properties as compared to the prior art. A suitable double belt press machine is shown in the Figures and discussed below. However, it is to be appreciated that any heated double belt press that is capable of carrying out the method of the present invention may be used and such apparatus will be immediately apparent to the person skilled in the art.

The pressure applied to the uncompressed felt layer by the double belt press may be any suitable pressure that acts to compress the material to a suitable gauge. In embodiments of the invention the pressure applied may be between 10 N/cm² and N/cm² 100 N/cm², between 20 N/cm² and 80 N/cm², between 30 N/cm² and 70 N/cm², or between 40 N/cm² and 60 N/cm², for example 55 N/cm².

In embodiments of the invention the primary fibrous material may be polyester. However, other suitable materials may be used and such materials will be immediately apparent to the person skilled in the art. One suitable alternative material is polyactic acid, which may be obtained from natural sources. The primary fibrous material may be polyactic acid or may be a mixture of polyester and polyactic acid fibres or may be any other suitable material. In addition to the primary fibrous material the felt layer may comprise further fibrous material of a lower melting point than the primary fibrous material. The primary fibrous material will comprise at least 50% of the felt layer and may comprise 60%, 70%, 80%, 90% or 100% of the felt layer.

If the primary fibrous material is polyester it may be a virgin material or a recycled material or a mixture thereof. Polyester fibre used in the present invention may have any suitable degree of coarseness, for example 1-12 dtex.

In embodiments of the invention the felt layer or the compressed material may be coated with a powder adhesive on one or both sides prior to passing through a double belt press or any other suitable heating and compression machine. It is generally advantageous that a double belt press, as used to compress the uncompressed felt layer of the present invention, is used to heat and compress a powder adhesive applied to a material. For this reason the description set out below refers to a double belt press but, where appropriate, this should be understood to refer to a double belt press or any other machine that could be used for heating and compressing a powder adhesive on a flat material.

Suitable powder adhesives include, but are not limited to, polycaprolactone, ethylene vinyl acetate, polyurethane, polyester, or polyamide powder or any suitable combination thereof. Coating with powder adhesives may be done to give bonding properties to the final material produced by the method of the present invention.

Generally, it may be advantageous that opposing sides of the material are coated separately. That is, a first side of the material may be coated with the powder adhesive, the material is then be passed through a heated double belt press to adhere the powder adhesive to the first side of the material and then subsequently a second side of the material may be coated with the powder adhesive and the material is then passed through a heated double belt press to adhere the powder coating to the second side of the material. In alternative embodiments of the invention both a first side and a second side of the material may be coated simultaneously.

Coating of a material with a powder adhesive may be carried out as an additional process step, after the heating and compression of the uncompressed felt layer. For example, after heating, compression, and cooling of the felt layer in accordance with the method of the present invention, the compressed material may be coated on one or both sides and then passed through a heated double belt press to compress and adhere the powder coating to the compressed material. Alternatively, coating of one or both sides may be carried out simultaneously with the heating and compression of the uncompressed felt layer.

Coating of a material with a powder adhesive on one or both sides may be carried out as an additional process step or as an in-line process with the heating and pressing of the uncompressed felt layer or as an in-line process with the forming of a laminate material or sandwich material.

As will be readily understood, the heating and compression of an adhesive powder coating may be carried out at lower temperatures and pressures than the heating and compression of the uncompressed felt layer and may be carried out at higher processing rates, if it is done subsequent to the heating and compression of the uncompressed felt layer. For example, it may only be necessary to heat a powdered adhesive layer to less than 150 C, less than 120 C, or less than 100 C. In embodiments of the invention a temperature of 90 C may be used to heat a powdered adhesive coating. Similarly, pressures of less than 50 N/cm², less than 40 N/cm², less than 30 N/cm², or less than 20 N/cm² may be sufficient to compress a powdered adhesive layer. In embodiments of the invention a pressure of 10 N/cm² to compress a powdered adhesive coating.

In accordance with the method of the present invention the uncompressed felt layer is heated to within 20° C. of the melting point of the primary fibrous material. In embodiments of the invention the felt layer may be heated to within 15° C., 10° C., or 5° C. of the melting point of the primary fibrous material or to the melting point of the primary fibrous material. Heating the primary fibrous material to the melting point of the primary fibrous material is believed to obtain a stiffer final material.

Generally, in embodiments of the invention the thickness of the compressed material will be between 0.5 mm and 2.5 mm. Thickness of less than 0.5 mm are not desired as the stiffener material can develop a brittle crystalline structure. Maintaining the material to have a thickness of greater than 0.5 mm has been found to avoid this problem. The maximum thickness, which may be for example be 2.5 mm, is the maximum thickness at which relatively uniform heating and cooling of the felt layer can be achieved.

In embodiments of the invention the density of the compressed material may be between 0.4 g/cm³ and 1.1 g/cm³. Materials of this density are believed to be suitable for use in stiffening components of footwear. In order to form materials of this density it has been found that using an uncompressed felt layer having a density of 0.08 to 0.16 g/cm³ is generally suitable.

The double layer press of the present invention can be ran at any suitable speed. It is anticipated that the skilled person will be able to determine a suitable speed for running the press. For example, the speed at which the machine is ran may be greater than 1 m/min and may be less than 30 m/min. For the step of density passing the uncompressed felt layer through a double belt press speeds at the lower end of this range may be preferred. For example, it may be preferred that the double belt press is operated at speeds of less than 10 m/min or less than 5 m/min. For subsequent process of laminating material and/or coating material, as discussed above, it may be preferred that the double belt press is operated at higher speeds, for example at speeds above 15 m/min or above 20 m/min.

The stiffener material of the present invention may be a single layer material formed as the direct output of the method of claim 1 of the present invention. In embodiments of the invention the stiffener material may undergo further processing. For example, the method may further comprise the subsequent step of forming a laminate material comprising two or more layers of the compressed material. In addition or alternatively, the method may further comprise a subsequent step of forming a sandwich material comprising two layers of the compressed material having a filler material between the two layers of the compressed material. Any suitable filler material bay be used, for example virgin or recycled materials. In some embodiments of the present invention shredded lining materials may be used as a filler material or a powdered waste material may be used. Coating of a material with a powder adhesive may be carried out an in-line process with the forming of a laminate material or sandwich material. That is, the coating of the material may be carried out simultaneously with the formation of a laminate or sandwich material.

The formation of a laminate or sandwich material according to the present invention may be carried using a double belt press or any similar machine. If a double belt press is used this may be the same double belt press that is used to form the compressed material.

If a double belt press machine is used to form a laminar or sandwich material then it is generally advantageous that it is operated at the same speed and/or temperature and/or pressure as the double belt press machine is operated to form the laminate and sandwich material. It is to be understood that the skilled person will understand the optimum conditions at which to operate a double belt press in order to form a laminar or sandwich material.

The present invention also provides a stiffener a stiffener material made according to the method of the present invention. In particular, the present invention provides a stiffener material made from a compressed felt comprising a primary fibrous material, wherein the density of between 0.4 and 1.1 g/cm³ and a thickness of between 0.5 and 2.5 mm. The material may have any of the properties and/or components set out above in the description of the method of the present invention. For example, the material may have a powder coating, may be a laminated material of two, three, four, or more layers, and may be a sandwich material having a filler material between two layers of the compressed material.

The stiffener material of the present invention may be used to form a toe puff, heel counter, insole, or any other stiffening component, for footwear or any other product that requires stiffening in a similar manner.

Materials having a density of between 0.4 g/cm³ and 1.1 g/cm³ are believed to be suitable for use in stiffening components of footwear. In order to form materials of this density it has been found that using an uncompressed felt layer having a density of 0.08 g/cm³ to 0.16 g/cm³ is advantageous.

Further features and advantages of the present invention will be apparent from the embodiments of the invention discussed below and shown in the Figures.

### DRAWINGS

FIG. 1 is a schematic of a double belt press suitable for use in the method of the present invention; and

FIG. 2 is a graph showing the thickness of stiffener materials produced according to the present invention using the double press of FIG. 1;

FIG. 3 is a graph showing the density of stiffener materials produced according to the method of the present invention using the double press of FIG. 1;

FIG. 4 is a graph showing of the stiffness of stiffener materials produced according to the method of the present invention using the double press of FIG. 1;

FIG. 5 is a schematic of a three-step double belt process for forming a coated laminate material;

FIG. 6 is a schematic of a two-step double belt process for forming a coated laminate material;

FIG. 7 is a graph showing the weight of stiffener materials produced according to the present invention;

FIG. 8 is a graph showing the thickness of stiffener materials produced according to the present invention;

FIG. 9 is two graphs showing the density of stiffener materials produced according to the present invention;

FIG. 10 is two graphs showing the density of stiffener materials produced according to the present invention; and

FIG. 11 is two graphs showing the stiffness of stiffener materials according to the present invention.

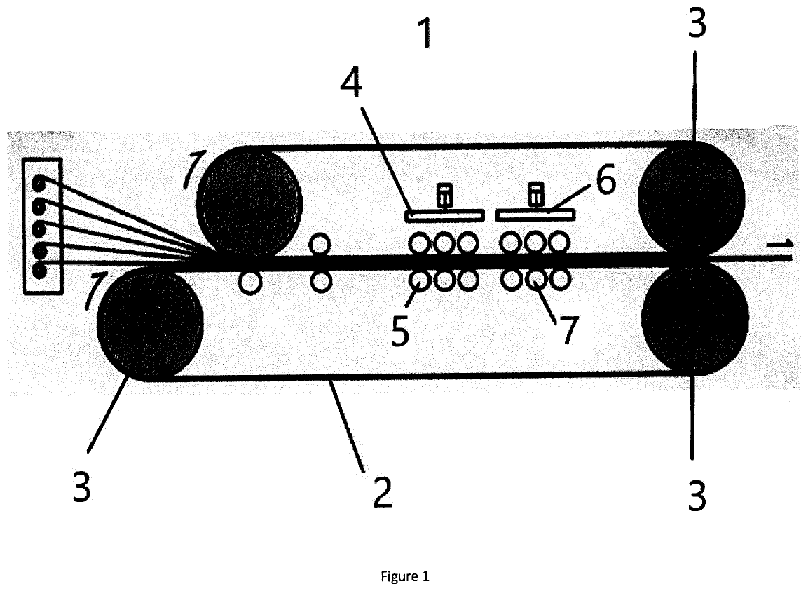

A schematic of a belt press 1 suitable for use in the present invention is shown in FIG. 1. The belt press 1 comprises two counter rotating unperforated belts 2, each mounted about a roller 3 at each end. The belts 2 are controlled to rotate in a suitable direction to pull a material through the belt press and compress the material. Hot plates 4 are provided to heat the material via the belts 2 and hot rollers 5. The hot plates 4 are heated using oil or an electric power unit (not shown). Cooling plates 6 are also provided. Cold water flows into through the cooling plates 6 and associated cold rollers 7 via a centrifugal pump (not shown). The belts 2 are supported by the rollers 3, the hot and cold rollers 5, 7 with pressure being applied to a material along a full length of the belt press with belt distances being adjustable from a central control board.

The belt press 1 of FIG. 1 was operated in accordance with the present invention on a uncompressed felt material consisting of polyester (PET) fibres to produce a stiffener material having a thickness between 0.5 mm and 2.5 mm. The melting point of the PET fibre is between 245 and 260° C. and the belt press 1 was operated to heat the felt material to between 240° C. and 245° C. The belt press 1 was operated at a pressure of between 50 and 60 N/cm². This increased the density of the uncompressed felt material 0.08-0.16 g/cm³ up to a range of 0.4-1.1 g/cm³ on the finished product as follows. Details of the uncompressed felt material used are as set out in Table 1 below:

TABLE 1
Uncompressed felt samples used showing
initial density.

| Weight | Gauge | Density |
|---|---|---|
| gsm | mm | g/cm³ |
| 256 | 2.7 | 0.0948 |
| 279 | 2.81 | 0.099288 |
| 530 | 3.5 | 0.151429 |
| 500 | 3.4 | 0.147059 |
| 600 | 3.8 | 0.157895 |
| 550 | 3.6 | 0.152778 |

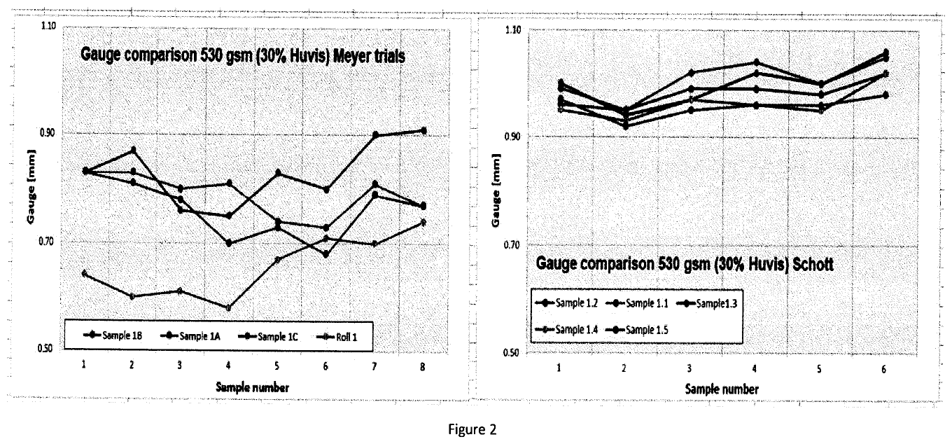

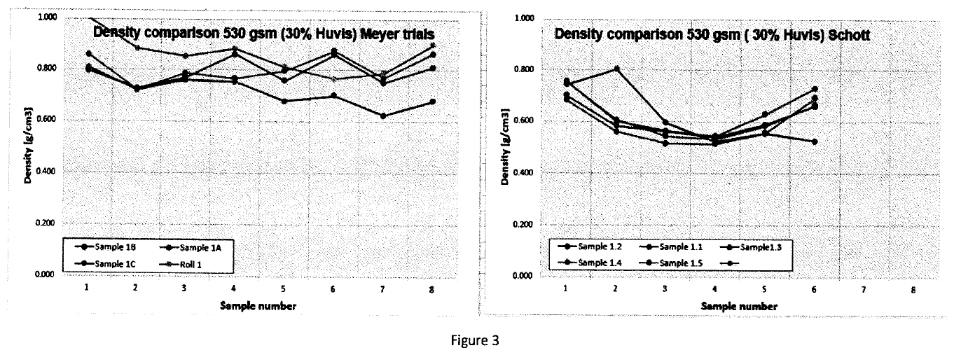

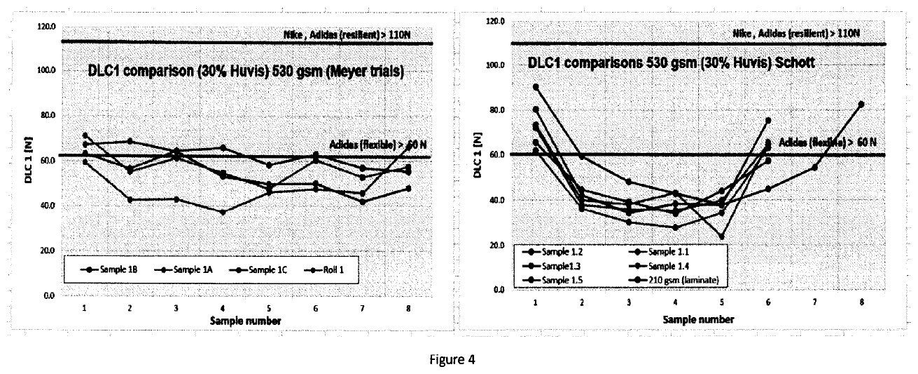

Details of the thickness of the stiffener materials produced according to the present invention from the samples set out above are shown in FIG. 2. Details of the density of the stiffener materials are shown in FIG. 3. Details of the DLC (stiffness) in Newtons are shown in FIG. 4. From the data shown in these Figures it can be seen that stiffener materials of thicknesses between 0.5 mm and 2.5 mm, stiffnesses of between 20 and 100 N, weights of between 500 and 750 gsm can be produced using the method of the present invention.

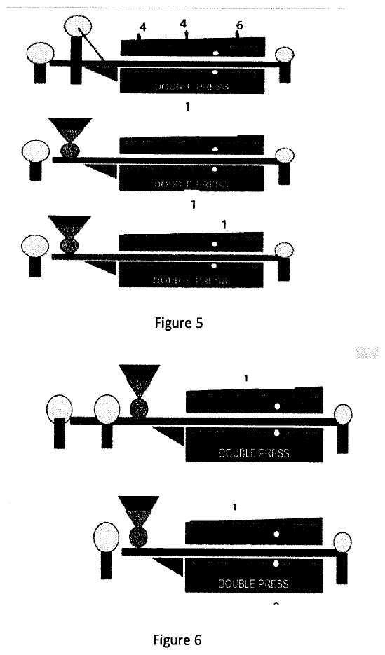

FIG. 5 shows a three-step process for forming a laminar material according to the present invention. The process uses a double belt press 1 with hot plates 4 and cooling plates 6 substantially in accordance with FIG. 1. In the first step, two 250 gsm sheets of compressed material formed in the manner described immediately above are fed through the double belt press 1 operating at a feed speed of 8 m/min with a pressure of 55 N/cm². The double belt press 1 is operated at a temperature of 247 C. This first step acts to form a laminated uncoated stiffener material.

In the second step a first side of the laminated material is powder coated with a powder adhesive and passed through a double belt press 1 operating at feed speed of 20 m/min, a pressure of 10 N/cm², and a temperature of 90 C. This forms a laminated stiffener material that is coated on the first side.

In the third and final step a second side of the laminated stiffener material is coated with a powder adhesive and the material is passed through a double belt press 1 operating at feed speed of 20 m/min, a pressure of 10 N/cm², and a temperature of 90 C. This forms a laminated stiffener material that is coated on both the first side and the second side.

The double belt press 1 of the first, second and third steps may either be the same double belt press or two, or three separate double belt presses may be used.

FIG. 6 shows a two-step process for forming a laminar material according to the present invention.

The process uses a double belt press 1 with hot plates 4 and cooling plates 6 substantially in accordance with FIG. 1. In the first step, two 250 gsm sheets of compressed material formed in the manner described immediately above are fed through the double belt press 1 operating at a feed speed of 8 m/min with a pressure of 55 N/cm², at a temperature of 247 C. Before being passed through the double belt press 1 a first side of the uppermost sheet is coated with a powder adhesive. This forms a laminated stiffener material that is coated on the first side.

In a second and final step a second side of the laminated stiffener material is coated with a powder adhesive and the material is passed through a double belt press 1 operating at feed speed of 20 m/min, a pressure of 10 N/cm², and a temperature of 90 C. This forms a laminated stiffener material that is coated on both the first side and the second side.

The double belt press 1 of the first and second steps may either be the same double belt press or two, or three separate double belt presses may be used.

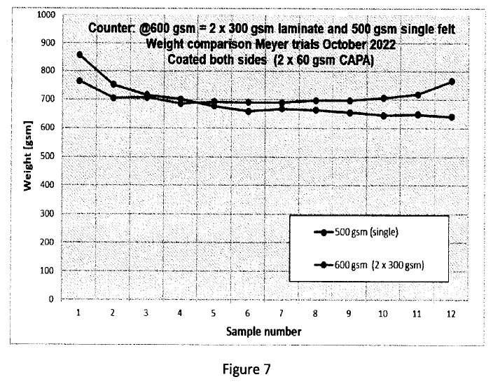

The powder adhesive used in the methods of FIGS. 6 and 7 is a caprolactone coating.

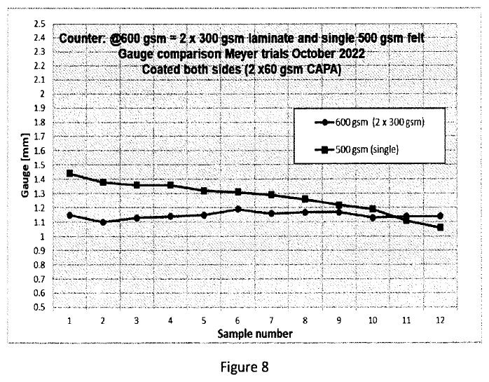

FIGS. 7 and 8 show the weight and gauge of samples according to the present invention that are either laminar stiffener materials formed of two 300 gsm sheets or stiffener material formed of a single 500 gsm sheet formed according to the present invention. The stiffener materials are coated on both sides with a 60 gsm caprolactone coating.

The weight and gauge of coated stiffener materials according to the present invention are set out in Tables 2 and 3 below. The laminar stiffener material is formed according to the two-step process set out above.

TABLE 2
Weight (g/m2) of coated materials formed in a two-step process
Weight (g/m2)

| 600 gsm | 500 gsm | 1000 gsm (2 × 500 | 1000 gsm (2 × 500 |
|---|---|---|---|
| (2 × 300 gsm) | (single) | gsm) Speed 3.2 | gsm) Speed 2.7 |
| 765 | 856 | 1295 | 1439 |
| 705 | 752 | 1171 | 1236 |
| 707 | 715 | 1138 | 1201 |
| 686 | 701 | 1107 | 1170 |
| 692 | 677 | 1098 | 1163 |
| 690 | 659 | 1108 | 1165 |
| 689 | 667 | 1094 | 1163 |
| 697 | 663 | 1108 | 1167 |
| 697 | 655 | 1134 | 1188 |
| 706 | 645 | 1139 | 1202 |
| 718 | 648 | 1195 | 1252 |
| 766 | 640 | 1300 | 1340 |

TABLE 3
Gauge (mm) of coated materials formed in a two-step process
Gauge (mm)

| 600 gsm (2 × | 500 gsm | 1000 gsm (2 × 500 | 1000 gsm (2 × 500 |
|---|---|---|---|
| 300 gsm) | (single) | gsm) Speed 3.2 | gsm) Speed 2.7 |
| 1.15 | 1.44 | 1.89 | 1.89 |
| 1.1 | 1.38 | 1.9 | 1.88 |
| 1.13 | 1.36 | 1.92 | 1.89 |
| 1.14 | 1.36 | 1.93 | 1.93 |
| 1.15 | 1.32 | 1.94 | 1.92 |
| 1.19 | 1.31 | 2.05 | 1.96 |
| 1.16 | 1.29 | 2.06 | 1.94 |
| 1.17 | 1.26 | 2.06 | 1.9 |
| 1.17 | 1.22 | 2 | 1.9 |
| 1.13 | 1.19 | 1.94 | 1.92 |
| 1.14 | 1.11 | 1.95 | 1.88 |
| 1.14 | 1.06 | 1.94 | 1.87 |

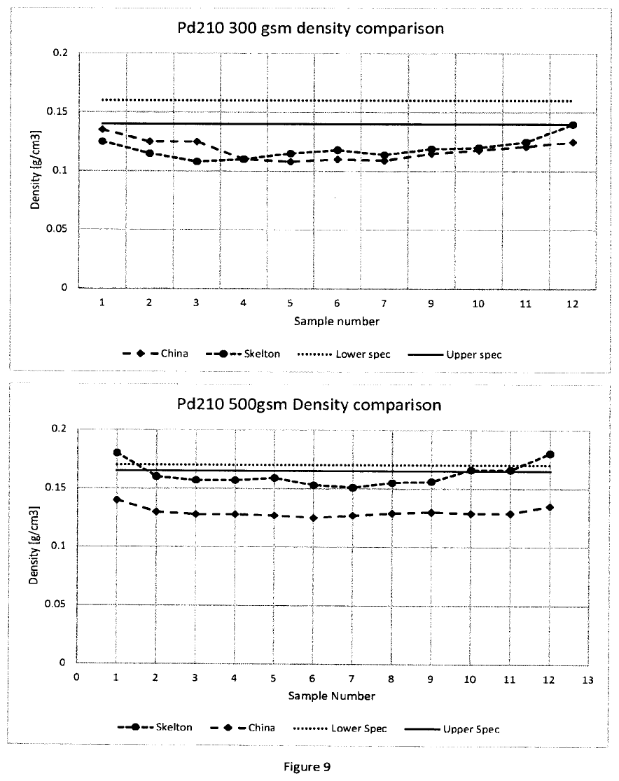

FIG. 9 shows the density of various samples of material formed according to the present invention of either 300 gsm or 500 gsm, as compared to the upper and lower specification levels.

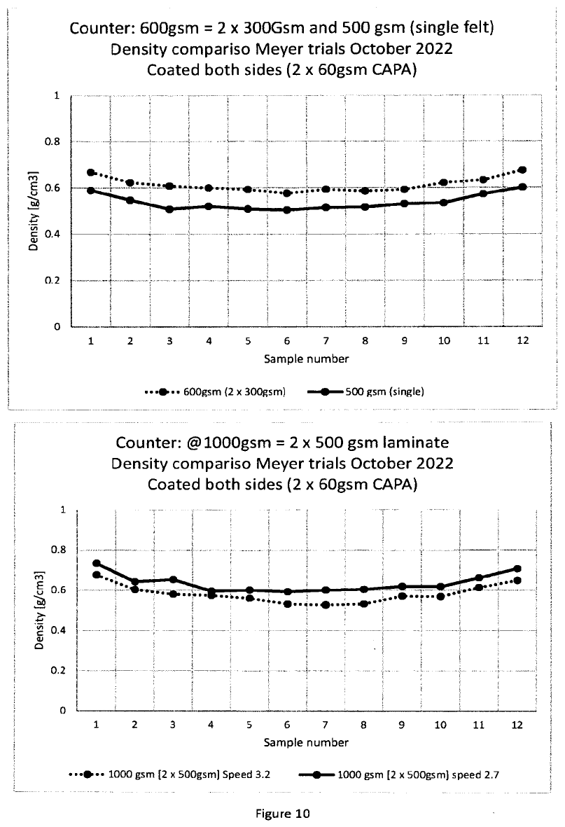

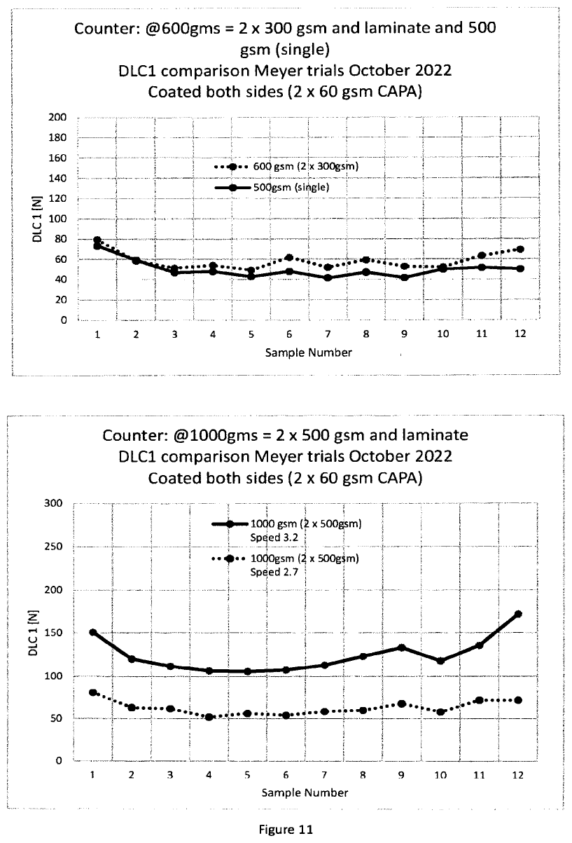

FIG. 10 shows the density of various samples of material formed according to the present invention. The samples being either 500 gsm single layer material, a laminate material formed of two layers of 300 gsm material, or a 1000 gsm laminate material formed of two layers of 500 gsm material. The two 1000 gsm laminate materials were formed at machine speeds of either 2.7 m/min or 3.2 m/min. As can be seen, the 1000 gsm material formed at a higher speed generally had a lower density. All the materials in FIG. 10 have a density of greater than 0.4 g/cm³. The data from FIG. 10 is shown in Table 4 below.

TABLE 4
Density (g/cm3) of samples according to the present invention
Density (g/cm³)

| | | 1000 | 1000 |
|---|---|---|---|
| | | gsm (2 × 500 | gsm (2 × 500 |
| 600 gsm (2 | 500 | gsm) | gsm) |
| × 300 | gsm | Speed | Speed |
| gsm | (single) | 3.2 | 2.7 |
| 0.6674 | 0.5887 | 0.6759 | 0.734 |
| 0.6226 | 0.5462 | 0.6036 | 0.6425 |
| 0.607 | 0.5079 | 0.5809 | 0.6536 |
| 0.5989 | 0.5202 | 0.5745 | 0.5963 |
| 0.5919 | 0.5081 | 0.5599 | 0.6012 |
| 0.5749 | 0.5039 | 0.5313 | 0.593 |
| 0.5917 | 0.5142 | 0.5271 | 0.6015 |
| 0.5849 | 0.5159 | 0.5322 | 0.6046 |
| 0.5909 | 0.5305 | 0.5713 | 0.6198 |
| 0.6206 | 0.5334 | 0.5685 | 0.6181 |
| 0.632 | 0.572 | 0.6135 | 0.6621 |
| 0.6747 | 0.5998 | 0.6493 | 0.7077 |

FIG. 11 shows the stiffness of various samples of material formed according to the present invention. The samples being either 500 gsm single layer material, laminate material formed of two layers of 300 gsm material, or 1000 gsm laminate material formed of two layers of 500 gsm material. All of these materials were coated on both sides with a 60 gsm CAPA layer. The two 1000 gsm laminate materials were formed at machine speeds of either 2.7 m/min or 3.2 m/min. As can be seen, the 1000 gsm laminate material formed at a higher speed generally had a higher stiffness. The data from FIG. 11 is shown in Table 5 below.

TABLE 4
Stiffness (N) of laminate materials vs single layer materials
DLC (N)

| | | 1000 | 1000 |
|---|---|---|---|
| | | gsm (2 × | gsm (2 × |
| | | 500 | 500 |
| 600 | 500 | gsm) | gsm) |
| gsm (2 × 300 | gsm | Speed | Speed |
| gsm) | (single) | 3.2 | 2.7 |
| 79.53 | 73.39 | 150.95 | 80.96 |
| 58.39 | 59.37 | 120.03 | 62.87 |
| 51.43 | 46.85 | 111.61 | 61.56 |
| 54.01 | 47.94 | 106.4 | 51.76 |
| 49.2 | 42.68 | 105.75 | 56.2 |
| 61.86 | 47.94 | 107.3 | 53.95 |
| 51.91 | 41.39 | 112.8 | 58.31 |
| 59.32 | 47.04 | 123 | 59.82 |
| 52.83 | 41.61 | 133 | 67.55 |
| 52.09 | 49.93 | 117.82 | 57.93 |
| 63.36 | 51.58 | 135.67 | 71.55 |
| 69.36 | 50 | 171.78 | 71.66 |

Unless otherwise indicated by context the description of the embodiments of the present invention set out above are for illustrative purposes only to explain the present invention. Any feature of the present invention discussed above may be implemented separately form any other feature.

1. A method of manufacturing a stiffener material comprising:
providing an uncompressed felt layer comprising a primary fibrous material having a density of between 0.08 g/cm³ and 0.16 g/cm³;
passing the felt layer through a double belt press; wherein
as the felt layer is passed through the double belt press it is maintained under constant pressure whilst first being heated to within 20° C. of a melting point of the primary fibrous material and is subsequently cooled to below the glass temperature of the primary fibrous material to form a compressed material.

2. A method according to claim 1, wherein the primary fibrous material is polyester.

3. A method according to claim 2, wherein the felt layer consists solely of the primary fibrous material.

4. A method according to claim 1, wherein the felt layer comprises a second fibrous material having a lower melting point than the primary fibrous material.

5. A method according to claim 1, wherein the compressed material is coated with a powder adhesive on one or both sides and the compressed material is then passed through a heated double belt press.

6. A method according to claim 5, wherein the compressed material is coated with a powder adhesive on both sides and the compressed material is then passed through a heated double belt press.

7. A method according to claim 5, wherein the compressed material is coated with a powder adhesive on a first side and the compressed material is then passed through a heated double belt press;
then the compressed material is coated with a powder adhesive on a second side, opposing the first side, and the compressed material is then passed through a heated double belt press.

8. A method according to claim 5, wherein the heated double belt press is operated at a temperature of less than 150 C and a pressure of less than 20 N/cm².

9. A method according to claim 1, wherein the uncompressed felt material is coated with a powder adhesive on one or both sides before the uncompressed felt material is passed through the heated double belt press.

10. A method according to claim 9, wherein the uncompressed felt material is coated with a powder adhesive on both sides before the uncompressed felt material is passed through the heated double belt press.

11. A method according to claim 9, wherein the uncompressed felt material is coated with a powder adhesive on a first side before the uncompressed felt material is passed through the heated double belt press;
and then the compressed material is coated with a powder adhesive on a second side, opposing the first side, and is then passed through a heated double belt press.

12. A method according to claim 5, wherein the powder adhesive is one or more of polycaprolactone, ethylene vinyl acetate, polyurethane, polyester, or polyamide powder.

13. A method according to claim 1, wherein the uncompressed felt layer is heated to the melting point of the primary fibrous material as it is passed through the double-belt press.

14. A method according to claim 1, wherein the thickness of the compressed material is between 0.5 mm and 2.5 mm.

15. A method according to claim 1, wherein the density of the compressed material is between 0.4 g/cm³ and 1.1 g/cm³.

16. A method according to claim 1, further comprising the subsequent step of forming a laminate material comprising two or more layers of the compressed material.

17. A method according to claim 16, wherein the laminate material is formed by passing the layers through a heated double belt-press.

18. A method according to claim 1, further comprising the subsequent step of forming a sandwich material comprising two layers of the compressed material having a filler material between the two layers of the compressed material.

19. A method according to claim 18, wherein the sandwich material is formed by passing the layers of compressed material and the filler material through a heated double belt press.

20. A method according to claim 17, wherein the laminate material or the sandwich material is coated on at least one side before being passed through the heated double belt-press.

21. A method according to claim 20, wherein the laminate material or sandwich material is coated on both sides before being passed through the double belt press.

22. A method according to claim 20, wherein the laminate material or sandwich material is coated on a first side before being passed through the heated double belt press.

23. A method according to claim 22, wherein the laminate material or sandwich material is subsequently coated on a second side, opposing the first side, and is then passed through a heated double pres.

24. A method according to claim 16, wherein subsequent to forming the laminate material or sandwich material the material is coated on one or both sides and passed through a heated double belt press.

25. A stiffener material made according to the method of claim 1.
